(19) United States
(12) Patent Application Publication
(10) Pub. No.: US 2015/0242533 A1
(43) Pub. Date: Aug. 27, 2015

(54) Method and Apparatus for Analyzing Data Flows

(71) Applicant: Keysight Technologies, Inc., Minneapolis, MN (US)

(72) Inventors: ROLF MADSEN, AALBORG (DK); ASGER IVERSEN, AALBORG (DK); JANUS FAABORG, NORRESUNDBY (DK); JEFF DRALLA, LOS ALTOS, CA (US)

(73) Assignee: Keysight Technologies, Inc., Minneapolis, MN (US)

(21) Appl. No.: 14/191,314

(22) Filed: Feb. 26, 2014

(51) Int. Cl. G06F 17/30

(52) U.S. Cl. CPC G06F 17/30958; G06F 17/30598

(57) ABSTRACT

A method of operating a data processing system to display a plurality of list entries is disclosed. Each list entry includes a timestamp, an identifier, and a message. The method includes sorting the list entries by the identifier associated with the list entries and displaying a data flow chart on a display associated with the data processing system. The data flow chart has a plurality of rows. Each row is a graphical view of the list entries having a given identifier. Each row includes a graphical element representing each message and a row label indicating the identifier associated with that row. Each row has a time region representing a time axis on which the graphical elements are placed, each of the graphical elements being placed at a location in the time region determined by the timestamp associated with that message.

### BACKGROUND

Many systems generate logs consisting of messages that are generated at various times during the operation of the system by various components in the system. The log entries typically include a timestamp, some identifier that indicates which component is generating the message and a message. In a system that operates in a sequential manner, such logs allow the user to track the operation of the system in a reasonably efficient manner. However, even in such simple systems, achieving an overview of the operation can be impeded by the amount of detail that is contained in the log. If the system reporting has a very fine grain, only a small fraction of the messages is visible at any time. This sub-set of the messages typically covers a very small time interval, and hence, an overview of the entire process is difficult.

Systems that have a number of modules that are operating in parallel present significant addition challenges, as the log has messages from a number of modules. To arrive at an understanding of the overall operation, the user must separate the actions of the individual modules and understand those actions in their temporal context.

### SUMMARY OF THE INVENTION

The present invention includes a method of operating a data processing system to display a plurality of list entries. Each list entry includes a timestamp, an identifier, and a message. The method includes sorting the list entries by the identifier associated with the list entries and displaying a data flow chart on a display associated with the data processing system. The data flow chart has a plurality of rows. Each row is a graphical view of the list entries having a given identifier. Each row includes a graphical element representing each message and a row label indicating the identifier associated with that row. Each row has a time region representing a time axis on which the graphical elements are placed, each of the graphical elements being placed at a location in the time region determined by the timestamp associated with that message.

In one aspect of the invention, each of the list entries also includes a duration indicating a time span associated with an action that generated the entry. In this case, each of the graphical elements has a dimension along the time axis that is determined by the duration. If a row has two graphical elements that overlap in time, the row is divided into a plurality of sub-rows that display the graphical elements such that no two graphical elements overlap in time in any sub-row.

In another aspect of the invention, each of the list entries also includes a message type. The graphical elements in this aspect of the invention include a label that indicates the message type associated with the list entry corresponding to that graphical element.

In a still further aspect of the invention, the data processing system receives user information indicating a sub-region of the data flow chart and the data processing system displays the message corresponding to each graphical element in the sub-region. The message display can take the form of a table of the list entries corresponding to graphical elements within the sub-region. The table can include the message for each of the graphical elements in the sub-region, the identifier corresponding to that message, and the time-stamp corresponding to that message.

In another aspect of the invention, the data flow chart includes an indication of a number of graphical elements that overlap in time as a function of time as indicated by the timestamps. The indication can be generated for all messages having graphical elements displayed in the data flow chart or just those graphical elements corresponding to a given message type.

### BRIEF DESCRIPTION OF THE DRAWINGS

FIG. 1 illustrates a data flow chart according to one embodiment of the present invention.

FIG. 2 illustrates another embodiment of a data flow chart according to the present invention.

FIG. 3 illustrates another embodiment of a data flow chart according to the present invention.

FIG. 4 illustrates another embodiment of a data flow chart according to the present invention.

FIG. 5 illustrates another embodiment of a data flow chart according to the present invention.

FIG. 6 illustrates the generation of a message type parallelism graph.

### DETAILED DESCRIPTION

For the purposes of the present discussion, a list entry is defined to be a message from a module or program in which the message includes three fields, namely, a timestamp, an identifier indicating the source of the message, and a message body. To simplify the following discussion, the term module will be used for both modules within a program or individual programs unless specified otherwise. As will be explained in more detail below, a list entry can also include additional fields such as a duration associated with the action that generated the list entry.

For the purposes of this discussion, a log file is defined to be a collection of list entries from a plurality of modules in which the entries are displayed as a list that is ordered by one of the fields in the list items. For the purposes of the present examples, it will be assumed that the entries are ordered by a timestamp associated with each message. In the present invention, the data in a log file is displayed as a chart that provides a better overview of the activities of the various modules that have placed messages in the log file. The log file is typically ordered by the time stamps. In the present invention, the list items are grouped by the module associated with each list entry.

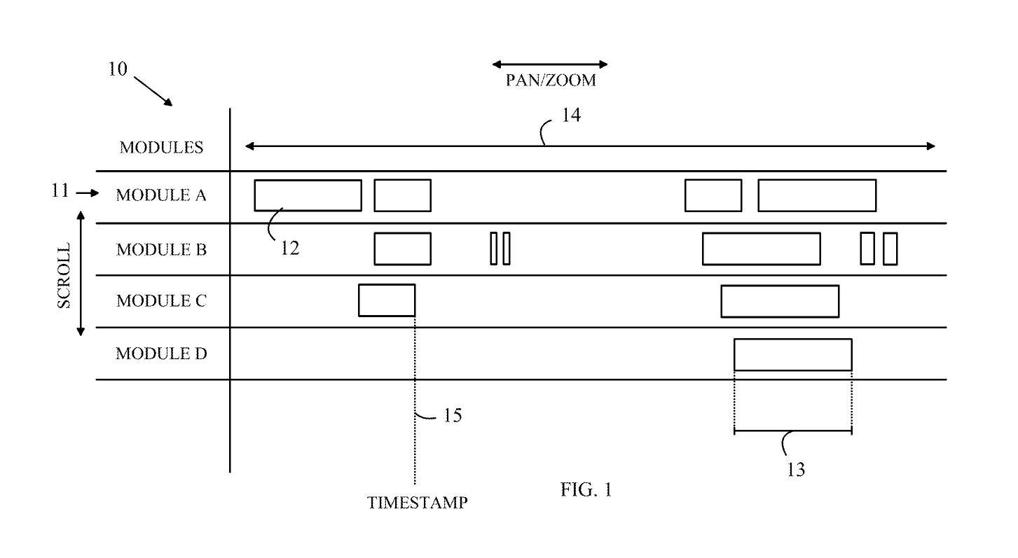

Refer now to FIG. 1, which illustrates a data flow chart according to one embodiment of the present invention. In the example shown in FIG. 1, each list entry includes a timestamp, a module identifier, a message, and a duration. Data flow chart 10 has a plurality of rows; an exemplary row is shown at 11. Each row represents the messages from a given module. The row shown at 11 represents the messages for Module A. Each message is represented by rectangle 12 that has a width that is determined by the message duration as shown at 13. The rectangle is placed at a location along the time axis shown at 14 that is determined by the timestamp in that message. In data flow chart 10, the rectangle is positioned such that the edge corresponding to the end of the duration interval is positioned at the timestamp as shown at 15.

If the number of rows is greater than the number that can be displayed on the monitor associated with the data processing system that implements the data flow chart, the user can scroll up or down to bring the information about the module(s) of interest into view. Similarly, the user can pan and zoom along the time axis to view a particular time period of interest or the individual messages.

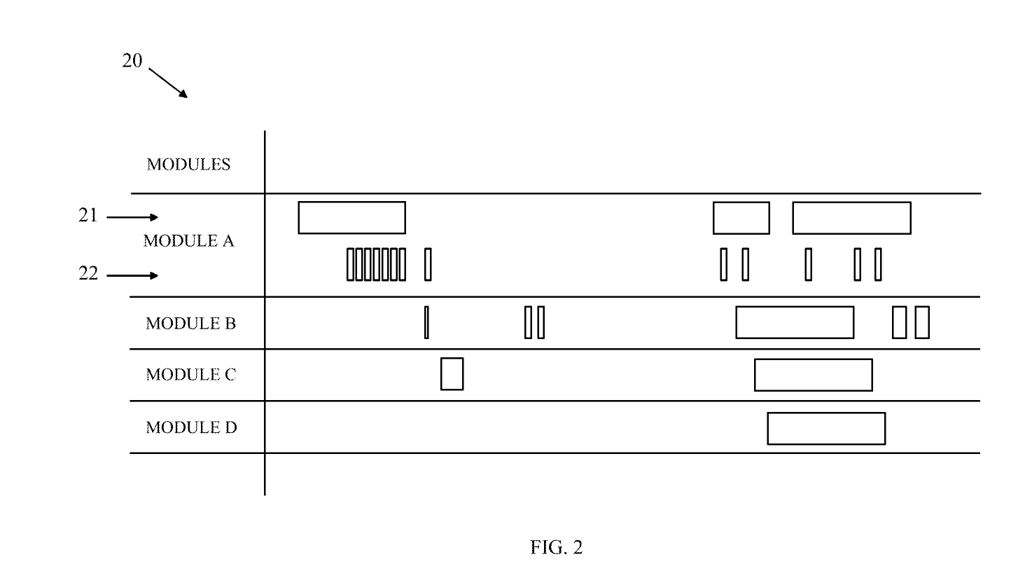

In the example shown in FIG. 1, each module only has one message active at any given time. However, the individual modules may have a number of messages that are active at any given time. Refer now to FIG. 2, which illustrates another embodiment of a data flow chart according to the present invention. Data flow chart 20 includes a row for Module A that has two sub-rows shown at 21 and 22. The sorting of the messages into the sub-rows can utilize a number of different algorithms. In the example shown in FIG. 2, the sub-rows are ordered by the duration of the messages, messages having longer durations being displayed by rectangles on higher sub-rows.

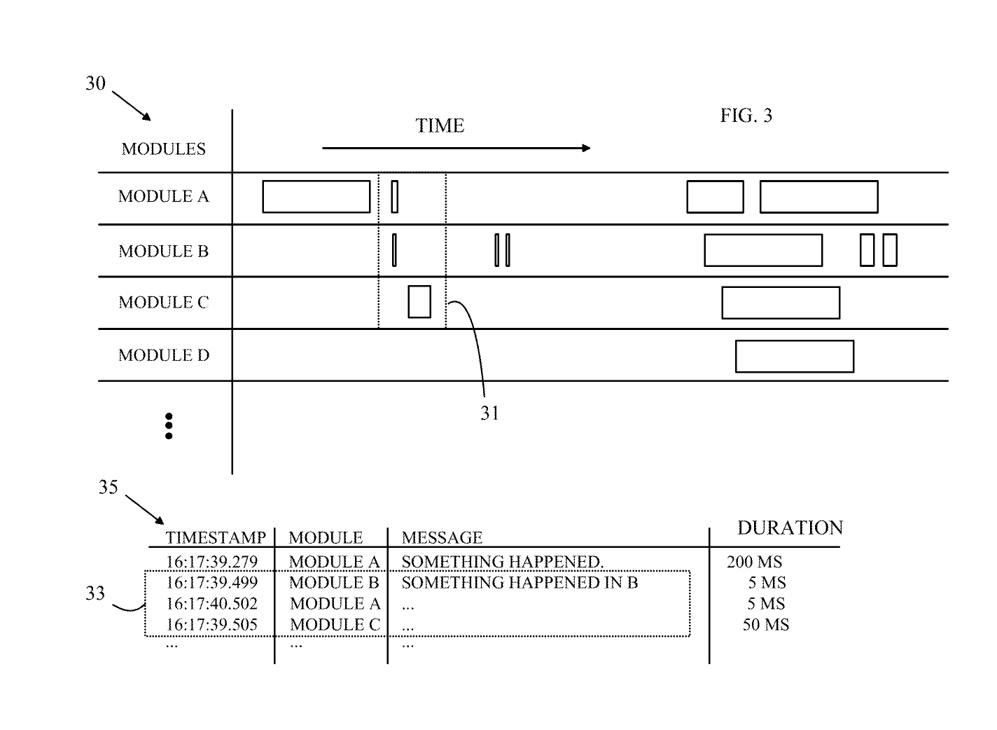

It should be noted that the exemplary displays shown in FIGS. 1 and 2 do not include the actual message text associated with each message. To view the actual text, the user selects a region of the data flow chart for a more detailed display. Refer now to FIG. 3, which illustrates another embodiment of a data flow chart according to the present invention. Data flow chart 30 includes a list window 35 that provides a listing of the messages that the user selects using a pointer to select a region 31 of data flow chart 30 corresponding to a particular group of modules and a time span. The listing window displays the detailed information about each message in the selected region. In this embodiment, list window 35 displays a portion of the list entries that are displayed in data flow chart 30 with the selected messages highlighted as shown at 33. Additional messages on either side of the timestamps of interest may also be displayed. In other embodiments, the items in list window 35 can be scrolled and data flow chart 30 automatically scrolls to a corresponding area so that the two windows display data on the same messages.

The arrangement shown in FIG. 3 is particularly useful in systems in which a log file listing is already implemented, since that listing can be scrolled to provide the data on the modules of interest. However, other schemes for displaying the details of selected messages could be utilized. For example, the user could “click” on a particular message and have the details of that message displayed in a pop-up window. In one embodiment, list window 35 is a pop-up table that is displayed when the user selects one or more messages shown in data flow chart 30 for more detailed display.

In other embodiments, this table of log entries is always visible to the user and always shows all the list entries that will fit within the window. It can be scrolled in a manner analogous to that used with a text file. Rows can be highlighted by the user or by selecting a region in the data flow chart which can be done by “clicking” a box corresponding to a message. If the user selects a subset of the rows, the same regions will be selected and displayed in the data flow chart.

In the above-described embodiments, the messages did not include any information that differentiates one message from another except for the information specifying the module and message duration. In another aspect of the present invention, the list entries include a type indicator that will be referred to as the message type indicator in the following discussion. The message type indicator could be a totally separate field in the log entries or be part of the message itself. For example, the first 50 characters of the message could be used as the message type indicator or the entire message could be used as the message type indicator.

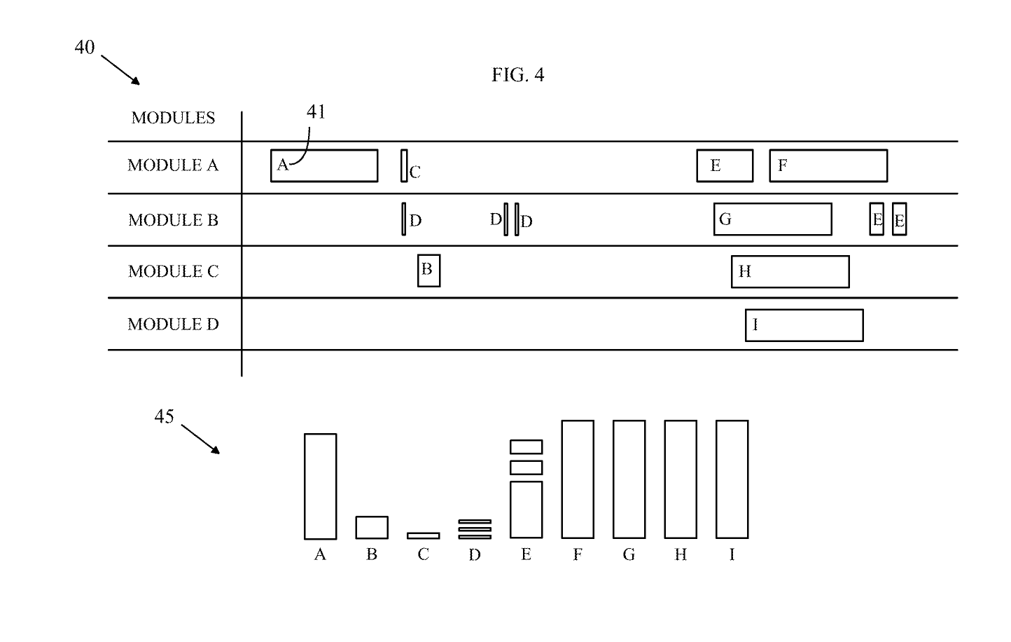

To simplify the following discussion, it will also be assumed that the message type indicator is a separate field and that the other fields discussed above are also present. Refer now to FIG. 4, which illustrates another embodiment of a data flow chart according to the present invention. In data flow chart 40, each rectangle corresponding to a message has a message type associated with that rectangle. To simplify the drawing, the message types are denoted by a single letter such as shown at 41. The message type denotes the type of activity that is taking place in the associated module during the time span of the duration associated with that message. In data flow chart 40, a separate chart 45 is provided that shows the amount of time spent on each activity. Chart 45 is generated by summing the times spent on each activity. In the example shown in FIG. 4, the individual message durations are also displayed so that the time spent on each individual activity of a particular type can also be visualized.

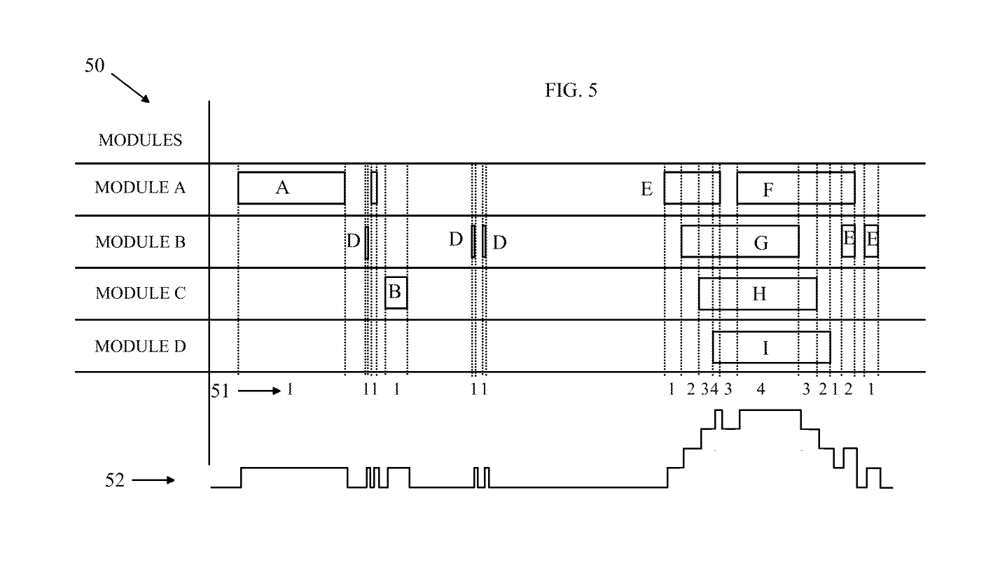

A data flow chart according to the present invention can also be used to gauge the level of “parallelism” in the system generating the messages. If messages from two modules overlap, then those modules are generating messages indicating the modules are running in parallel during that time. Refer now to FIG. 5, which illustrates another embodiment of a data flow chart according to the present invention. In data flow chart 50, the number of messages that are active at any given time are summed to provide the counts shown at 51. To simplify the drawing, the periods in which no messages are active are not labeled.

The data shown in data flow chart 50 can be viewed in a number of different ways to help the user understand the degree of parallelism involved in the underlying processes. In one aspect of the present invention, the counts shown at 51 are graphed as a function of time to provide a histogram that shows the number of activities that are operating in parallel at any given time independent of the type of activity. The information can also be graphed as shown at 52.

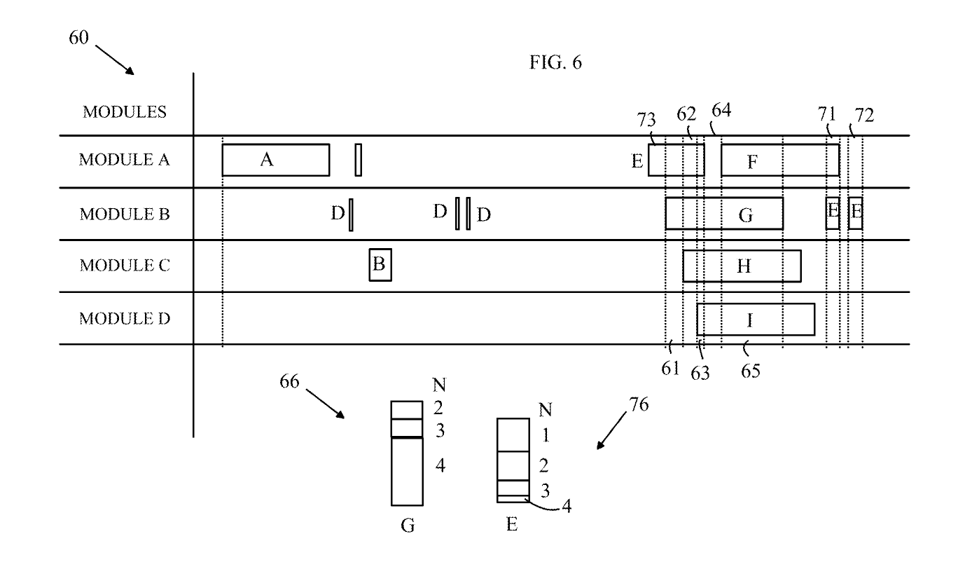

In another aspect of the invention, the level of parallelism associated with each type of activity can be displayed. This aspect allows the user to examine the number of activities that are going on in parallel with a particular type of activity of interest to the user. Consider activity type G shown in FIG. 5. Various other activities are going on in parallel with this activity, and the number of such activities changes over time. One type of graph that summarizes this information will be referred to a message type parallelism graph. A message type parallelism graph for a given message type is generated as follows. For each time at which the message type is active, count the number of other messages that are also active and the total time the messages were active in parallel. Refer now to FIG. 6, which illustrates this process for messages of the G. During time period 61, two activities are running in parallel as represented by messages G and E. During time period 62, three activities are running in parallel as represented by messages G, E and H. During time period 63, four activities are running in parallel. During time period 64, three activities are running in parallel. Finally, during time period 65, four activities are running in parallel. For each case in which N activities, including G, were running in parallel, sum the time periods. Hence, time periods 63 and 65 are summed and represent the case in which four activities were running in parallel. The remaining time periods do not require summing, as each has only one value of N. The time periods, after any summing, can be represented as a bar graph having blocks whose heights are proportional to the time spent with that value of N activities executing in parallel when G was one of the activities as shown at 66.

In the example shown in FIG. 6, message type G only appears once. However, the same method can be used to generate a message type parallelism graph for messages that appear multiple times, such as message type E. Time periods 72 and 73 have only message type E operative, and hence, correspond to an N of 1. These time spans will be added before generating the final graph. Time period 61 and time period 71 have an N of 2, and hence, must be added. Time period 62 has an N of 3, and time period 63 has an N of 4. The message type parallelism graph corresponding to message type E is shown at 76.

The generation of message type parallelism graphs can be triggered in a number of ways. For example, the user could select a particular message from the data flow chart and select the graph type from a menu. In another example, the data processing system could automatically generate a message type parallelism graph for each type currently within the portion of the data flow chart that is currently displayed. In yet another example, the user could specify a time range to be used in generating message type parallelism graphs and the message types to be included in such a graph.

The graphs can also be sorted in a number of ways for the display. For example, the graphs can be sorted by the total time spent on a given message type. This is just the height of the message type parallelism graph columns. In addition, the graphs can be grouped based on metrics such as the degree of parallelism as measured by different parallelism groups. For example, three groups of interest are “total” parallelism, “semi-parallelism”, and “non-parallelism”. Total parallelism occurs when N equal the number of modules. That is, all of the modules are operating in parallel. Non-parallelism corresponds to N=1. That is, no parallel processing is occurring for the message type of interest. Semi-parallelism corresponds to N from 2 to N−1.

In the above-described embodiments, the message text is not displayed within the rectangles used to indicate the presence of an activity denoted by the message. In one aspect of the invention, the message text is placed in the rectangle if there is sufficient space within the rectangle to display the text. As noted above, a data flow chart according to the present invention supports both a pan and zoom function that allows the user to zoom in on a particular subset of modules and/or times. Hence, the space available within a rectangle for displaying text can be increased by zooming in on the particular rectangle of interest. The added space is then used to display the message text and other information about the activity such as the activity type discussed above.

In many cases, the log file containing the data that is re-displayed in a data flow chart according to the present invention is stored and processed on a general purpose data processing system that includes a display and pointing device and is part of an instrument. The data flow charts discussed above are displays on such a display and the selection of groups of messages can be implemented with the pointing device. The present invention can also be implemented on a separate data processing system that has access to the log file from an instrument or system that generates the messages. The data flow chart can be generated in real time or from a stored log file.

In the above-described embodiments, the graphical elements are rectangles having a width that is determined by the duration of the message. In these embodiments, the form of the graphical element was independent of the message type. However, embodiments in which different graphical elements are used for different message types can also be constructed. The only constraint on the form of the graphical element is that the dimension of the graphical element along the time axis is determined by the duration associated with the message in question.

The present invention also includes a computer readable medium that stores instructions that cause a data processing system to execute the method of the present invention. A computer readable medium is defined to be any medium that constitutes patentable subject matter under 35 U.S.C. 101 and excludes any medium that does not constitute patentable subject matter under 35 U.S.C. 101. Examples of such computer readable media include non-transitory media such as computer memory devices that store information in a format that is readable by a computer or data processing system.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A method of operating a data processing system to display a plurality of list entries, each list entry comprising a timestamp, an identifier, and a message, said method comprising:
causing said data processing system to group said list entries by said identifier associated with said list entries; and
generating a data flow chart on a display associated with said data processing system, said data flow chart having a plurality of rows, each row being a graphical view of said list entries having a given identifier, said rows comprising graphical elements representing each message in that row, each row comprising a row label indicating said identifier associated with that row and a time region representing a time axis on which each of said graphical elements is placed, said graphical elements being placed at a location in said time region determined by said timestamp associated with that message.

2. The method of claim 1 wherein each of said list entries further comprises a duration indicating a time span associated with an action that generated said list entry, and wherein each of said graphical elements has a dimension along said time axis that is determined by said duration.

3. The method of claim 2 wherein each row having two graphical elements that overlap in time includes a plurality of sub-rows that display said graphical elements such that no two graphical elements overlap in time in any sub-row.

4. The method of claim 1 wherein each of said list entries further comprises a message type and wherein each of said graphical elements comprises a label that indicates said message type associated with said list entry corresponding to that graphical element.

5. The method of claim 1 further comprising:
receiving user information indicating a sub-region of said data flow chart and display; and
displaying said message corresponding to each graphical element in said sub-region.

6. The method of claim 5 wherein said displaying said message comprises generating a table of said list entries corresponding to graphical elements within said sub-region, said table including said message for each of said graphical elements in said sub-region, said identifier corresponding to that message, and said timestamp corresponding to that message.

7. The method of claim 2 further comprising providing an indication of a number of graphical elements that overlap in time in said graphical view as a function of time as indicated by said timestamps.

8. The method of claim 7 wherein each of said list entries further comprises a message type and wherein said data processing system displays a message type parallelism graph that represents a degree of parallel processes that is operative when a given message type is operative.

9. The method of claim 8 wherein said display comprises a plurality of message type parallelism graphs.

10. The method of claim 9 wherein said message type parallelism graphs are sorted on said display based on a total time messages of each type were active.

11. The method of claim 9 wherein said message type parallelism graphs are sorted by an indicator specifying a degree of parallelism in said messages of each type.

12. A computer readable medium comprising instructions that cause a data processing system to execute a method for operating a display that is part of said data processing system to display a plurality of list entries, each list entry comprising a timestamp, an identifier, and a message, said method comprising:
causing said data processing system to group said list entries by said identifier associated with said list entries; and
generating a data flow chart on a display associated with said data processing system, said data flow chart having a plurality of rows, each row being a graphical view of said list entries having a given identifier, said rows comprising graphical elements representing each message on that row, each row comprising a row label indicating said identifier associated with that row and a time region representing a time axis on which said graphical elements are placed, each of said graphical elements being placed at a location in said time region determined by said timestamp associated with that message.

13. The computer readable medium of claim 12 wherein each of said list entries further comprises a duration indicating a time span associated with an action that generated said list entry, and wherein each of said graphical elements has a dimension along said time axis that is determined by said duration.

14. The computer readable medium of claim 12 wherein each of said list entries further comprises a message type and wherein each of said graphical elements comprises a label that indicates said message type associated with said list entry corresponding to that graphical element.

15. The computer readable medium of claim 12 wherein said method further comprises:
receiving user information indicating a sub-region of said data flow chart and display; and
displaying said message corresponding to each graphical element in said sub-region.

16. The computer readable medium of claim 15 wherein said displaying said message comprises generating a table of said list entries corresponding to graphical elements within said sub-region, said table including said message for each of said graphical elements in said sub-region, said identifier corresponding to that message, and said timestamp corresponding to that message.

17. The computer readable medium of claim 13 further comprising providing an indication of a number of graphical elements that overlap in time in said graphical view as a function of time as indicated by said timestamps.

18. The computer readable medium of claim 17 wherein each of said list entries further comprises a message type and wherein said data processing system display a message type parallelism graph that represents a degree of parallel processes that is operative when a given message type is operative.

19. The computer readable medium of claim 18 wherein said display comprises a plurality of message type parallelism graphs.

20. The computer readable medium of claim 19 wherein said message type parallelism graphs are sorted by an indicator specifying a degree of parallelism in said messages of each type.
